(19) United States
(12) Patent Application Publication
(10) Pub. No.: US 2019/0004311 A1
(43) Pub. Date: Jan. 3, 2019

(54) CASING UNIT

(71) Applicant: Nidec Corporation, Kyoto (JP)

(72) Inventors: Takeyuki SHUTO, Kyoto (JP); Yoichi SEKII, Kyoto (JP)

(21) Appl. No.: 15/946,739

(22) Filed: Apr. 6, 2018

(30) Foreign Application Priority Data
Jun. 29, 2017 (JP) 2017-127108

(51) Int. Cl. G02B 26/10; G02B 26/08

(52) U.S. Cl. CPC G02B 26/10; H02K 5/04; G02B 26/0816

(57) ABSTRACT

This casing unit includes a housing unit and a casing arranged to house therein at least a portion of the housing unit, the housing unit including a housing arranged to house therein at least a portion of a rotary drive apparatus arranged to cause incoming light coming from a light source to be emitted to an outside of the rotary drive apparatus while changing the direction of the incoming light. The housing includes a first tubular portion being tubular, and arranged to extend along a central axis extending in a vertical direction; and a second tubular portion being tubular, and arranged to extend along the central axis below the first tubular portion. The first tubular portion is arranged to house therein at least a portion of the light source. The second tubular portion is arranged to house therein at least a portion of the rotary drive apparatus. A cavity radially inside of the housing includes a light path along which the incoming light travels. The housing further includes, at each of the first and second tubular portions, one or more housing positioning portions each of which is arranged to be in contact with the casing in at least one of an axial direction, a radial direction, and a circumferential direction. The housing is defined by a single monolithic member including the housing positioning portions.

### CROSS REFERENCE TO RELATED APPLICATIONS

This application claims the benefit of priority to Japanese Patent Application No. 2017-127108 filed on Jun. 29, 2017. The entire contents of this application are hereby incorporated herein by reference.

### BACKGROUND OF THE INVENTION

### 1. Field of the Invention

The present invention relates to a casing unit.

### 2. Description of the Related Art

A known scanner apparatus used for position recognition in a head-mounted display (HMD) or the like typically has installed therein a light source, an optical component, such as a mirror, arranged to reflect incoming light coming from the light source, and a motor arranged to rotate the optical component. A known scanner apparatus is described in, for example, JP-T 2009-518667.

The apparatus described in JP-T 2009-518667 includes a housing, a top module, and a bottom module. The housing is provided with a light source, and includes a side wall defining a light path for light emitted from the light source. The top module is arranged above the housing, and has light-receiving and processing devices installed therein. The bottom module is arranged below the housing, and has a rotating mirror to guide the light path installed therein. This apparatus may involve an increased number of parts to position and fix a plurality of modules having different structures, and an increased cost. In addition, a process of assembling the apparatus may be complicated, which may lead to a reduction in manufacturing efficiency.

### SUMMARY OF THE INVENTION

The present invention has been conceived to achieve commonality of parts in connection with a structure for positioning and fixing, and thus to achieve a reduced cost and increased manufacturing efficiency.

A casing unit according to a preferred embodiment of the present invention includes a housing unit and a casing arranged to house therein at least a portion of the housing unit, the housing unit including a housing arranged to house therein at least a portion of a rotary drive apparatus arranged to cause incoming light coming from a light source to be emitted to an outside of the rotary drive apparatus while changing a direction of the incoming light. The housing includes a first tubular portion being tubular, and arranged to extend along a central axis extending in a vertical direction; and a second tubular portion being tubular, and arranged to extend along the central axis below the first tubular portion. The first tubular portion is arranged to house therein at least a portion of the light source. The second tubular portion is arranged to house therein at least a portion of the rotary drive apparatus. A cavity radially inside of the housing includes a light path along which the incoming light travels. The housing further includes, at each of the first and second tubular portions, one or more housing positioning portions each of which is arranged to be in contact with the casing in at least one of an axial direction, a radial direction, and a circumferential direction. The housing is defined by a single monolithic member including the housing positioning portions.

According to the above preferred embodiment of the present invention, the housing is arranged to house therein at least a portion of the rotary drive apparatus arranged to cause the incoming light coming from the light source to be emitted to the outside of the rotary drive apparatus while changing the direction of the incoming light. In addition, the housing is positioned with respect to the casing through the housing positioning portions, each of which is an integral portion of the housing, so that commonality of parts can be achieved. This leads to a reduced cost and increased manufacturing efficiency.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical sectional view of a casing unit according to a first preferred embodiment of the present invention.

FIG. 2 is a perspective view of a housing unit according to the first preferred embodiment.

FIG. 3 is a vertical sectional view of the casing unit according to the first preferred embodiment.

FIG. 4 is a planar view of a housing according to the first preferred embodiment.

FIG. 5 is a vertical sectional view of a casing unit according to a modification of the first preferred embodiment.

### DETAILED DESCRIPTION OF THE PREFERRED EMBODIMENTS

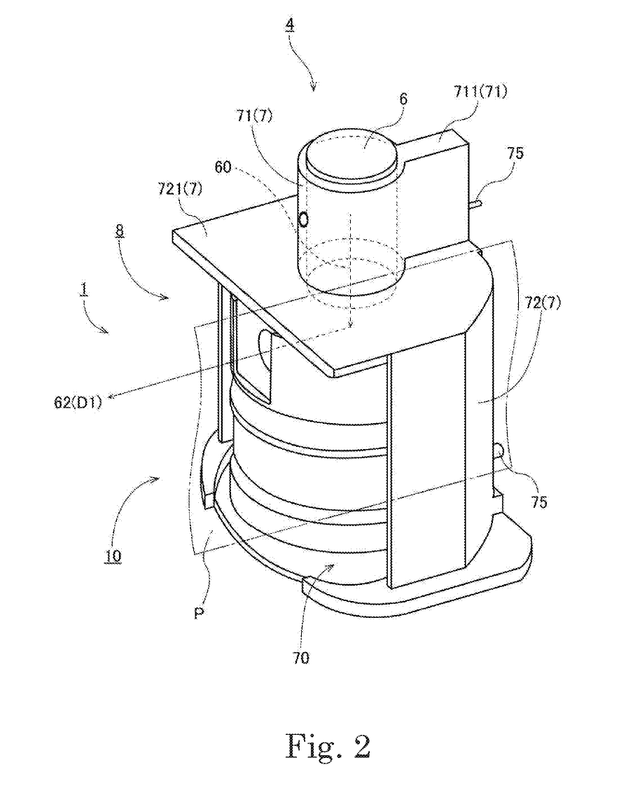

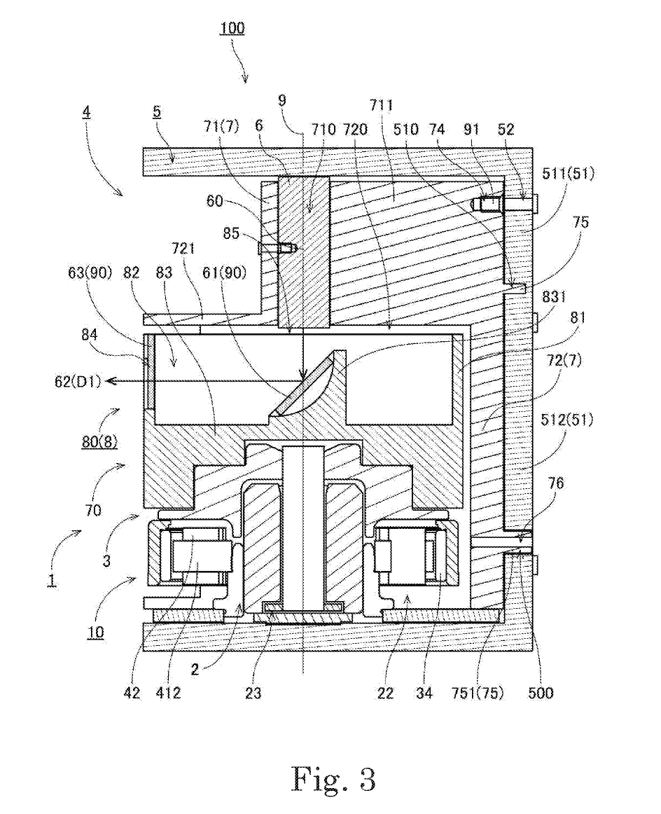

Hereinafter, preferred embodiments of the present invention will be described with reference to the accompanying drawings. It is assumed herein that a direction parallel to a central axis of a motor according to a first preferred embodiment of the present invention, which will be described below, is referred to by the term “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which a light source is arranged with respect to the motor is defined as an upper side. The shape of each member or portion and relative positions of different members or portions will be described based on the above assumptions. It should be noted, however, that the above definitions of the vertical direction and the upper and lower sides are not meant to restrict in any way the orientation of a casing unit according to any preferred embodiment of the present invention when in use. Also note that the term “parallel” as used herein includes both “parallel” and “substantially parallel”. Also note that the term “perpendicular” as used herein includes both “perpendicular” and “substantially perpendicular”. It is also assumed herein that a front side and a rear side of a housing correspond to a forward side and a rearward side, respectively, in a first radial direction D1, which will be described below, illustrated in FIGS. 2 and 3.

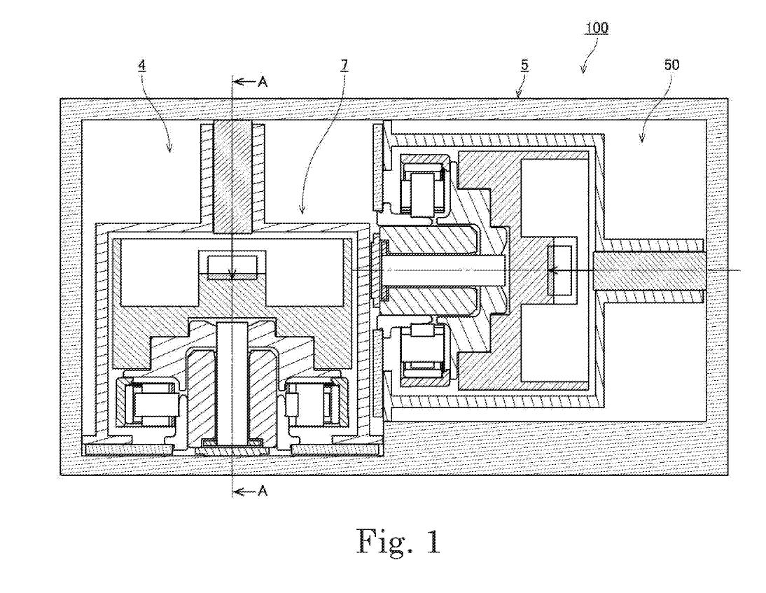

FIG. 1 is a vertical sectional view of a casing unit 100 according to a first preferred embodiment of the present invention. Referring to FIG. 1, the casing unit 100 includes two housing units and one casing 5. The two housing units include a housing unit 4 according to the present preferred embodiment. The two housing units are housed in the casing 5. Note that the number of housing units housed in the casing may alternatively be one or more than two. Also note that a portion of any housing unit may be arranged outside of the casing 5.

FIG. 2 is a perspective view of the housing unit 4 according to the first preferred embodiment. Referring to FIG. 2, the housing unit 4 includes a rotary drive apparatus 1, a light source 6, and a housing 7. At least a portion of the rotary drive apparatus 1 and at least a portion of the light source 6 are housed in the housing 7. In addition, each of the rotary drive apparatus 1 and the light source 6 is fixed to the housing 7.

The rotary drive apparatus 1 is an apparatus arranged to cause incoming light 60 coming from the light source 6 to be emitted to an outside of the rotary drive apparatus 1 while changing the direction of the incoming light 60. The light source 6 is arranged above the rotary drive apparatus 1. An optical axis of the light source 6 lies on a central axis 9 of a motor 10, which will be described below. The incoming light 60, which travels downward along the central axis 9, is emitted from the light source 6. The rotary drive apparatus 1 includes the motor 10 and a flywheel 8.

First, the structure of the motor 10 will now be described below. FIG. 3 is a vertical sectional view of the casing unit 100 taken along a plane indicated by line A-A in FIG. 1.

Referring to FIG. 3, the motor 10 includes a stationary portion 2 including a stator 22, and a rotating portion 3 including a magnet 34. The stationary portion 2 is arranged to be stationary relative to the housing 7 and the casing 5. In addition, the rotating portion 3 is supported through a bearing portion 23 to be rotatable about the central axis 9 with respect to the stationary portion 2.

Once electric drive currents are supplied to coils 42 included in the stationary portion 2, magnetic flux is generated around each of a plurality of teeth 412, which are magnetic cores for the coils 42. Then, interaction between the magnetic flux of the teeth 412 and magnetic flux of the magnet 34 included in the rotating portion 3 produces a circumferential torque between the stationary portion 2 and the rotating portion 3, so that the rotating portion 3 is caused to rotate about the central axis 9 with respect to the stationary portion 2. The flywheel 8 is thus caused to rotate about the central axis 9 together with the rotating portion 3.

A fluid dynamic bearing, for example, is used as the bearing portion 23. In this case, the stationary portion 2 and the rotating portion 3 are arranged opposite to each other with a gap therebetween, the gap having a lubricating oil arranged therein. A fluid dynamic pressure is induced in the lubricating oil while the motor 10 is running. Note that a bearing of another type, such as, for example, a rolling-element bearing, may alternatively be used as the bearing portion 23.

Next, the structure of the flywheel 8 will now be described below. The following description will be made with reference to FIGS. 1 to 3 appropriately.

The flywheel 8 is arranged below the light source 6 and above the motor 10, and is supported by an upper end portion of the rotating portion 3 of the motor 10. The flywheel 8 is fixed to an upper surface of the rotating portion 3 through, for example, engagement, an adhesive, or the like. The flywheel 8 includes a main body 80 and optical components 90, each of which is arranged to change the direction of the incoming light 60 or allow the incoming light 60 to pass therethrough. In the present preferred embodiment, the optical components 90 include a mirror 61 and a lens 63. The main body 80 is arranged to support each of the mirror 61 and the lens 63. A resin, for example, is used as a material of the main body 80. Glass, for example, is used as materials of the mirror 61 and the lens 63. The glass is not limited to particular types of glass. For example, organic glass, inorganic glass, a resin, or a metal may be used as the materials of the mirror 61 and the lens 63, but other materials may alternatively be used.

The main body 80 includes a tubular portion 81, a hollow portion 82, and a lower support portion 83. The tubular portion 81 is a cylindrical portion arranged to extend along the central axis 9. The hollow portion 82 is a cavity defined in the flywheel 8. In addition, a through hole 84, which is arranged to pass through the tubular portion 81 in the first radial direction D1, is defined in the tubular portion 81 at one circumferential position. The lens 63 or a lens frame (not shown), which is arranged to be in contact with a peripheral portion of the lens 63, is fitted and fixed in the through hole 84.

The lower support portion 83 is a portion of a lower portion of the flywheel 8, the portion lying inside of a peripheral portion of the lower portion of the flywheel 8. A lower surface of the lower support portion 83 defines at least a portion of a lower surface of the flywheel 8. The mirror 61 is fixed to a mirror support portion 831, which is defined integrally with an upper surface of the lower support portion 83. Note that the lower support portion 83 may include a cavity (not shown) defined on and around the central axis 9 of the motor 10 in a radially inner portion thereof. In addition, a portion of the incoming light 60 may pass through the mirror 61 and further travel downward through this cavity (not shown). In the present preferred embodiment, the tubular portion 81 and the lower support portion 83 are defined as a single monolithic member by a resin injection molding process. Note, however, that the tubular portion 81 and the lower support portion 83 may alternatively be defined by separate members.

The mirror 61 is in the shape of a plate, and is arranged to have a rectangular or circular external shape. The mirror 61 is fixed to a resin member of the mirror support portion 831 of the main body 80. In addition, a central portion of the mirror 61 is arranged on the central axis 9. In addition, a reflecting surface of the mirror 61 is inclined at an angle of 45 degrees with respect to the axial direction and the first radial direction D1. A fully reflective mirror, for example, is used as the mirror 61. The incoming light 60 impinges on a central portion of the mirror 61. The central portion of the mirror 61 refers to the entire mirror 61, excluding a peripheral portion of the mirror 61. The incoming light 60 is reflected by the mirror 61 inside of the flywheel 8, and is changed in direction to become reflected light 62. Note that, instead of the mirror 61, a prism (not shown) or the like may alternatively be used to change the direction of the incoming light 60.

The lens 63 is in the shape of a plate, and is arranged to have a rectangular or circular external shape. The lens 63 is fixed in the through hole 84 through, for example, adhesion or engagement directly or through the lens frame (not shown) arranged to be in contact with at least a portion of the peripheral portion of the lens 63. In addition, the lens 63 is arranged at right angles to the first radial direction D1, that is, in parallel with the central axis 9, in a state in which the lens 63 is fixed to the flywheel 8. As suggested above, the incoming light 60 is reflected by the mirror 61 inside of the flywheel 8 to become the reflected light 62. The reflected light 62 passes through a central portion of the lens 63 to be emitted to an outside of the flywheel 8.

The hollow portion 82, the mirror 61, and the lens 63 are arranged to overlap at least in part with each other when viewed in the first radial direction D1. Further, an upper surface of the main body 80 is provided with an opening 85. At least a portion of the flywheel 8 is exposed upwardly through the opening 85. The incoming light 60, which is emitted from the light source 6, comes from above the upper surface of the flywheel 8, passes through the opening 85, and travels downward along the central axis 9 in the hollow portion 82 radially inside of the tubular portion 81. Then, the incoming light 60 is reflected by the mirror to become the reflected light 62. The reflected light 62 further travels in the first radial direction D1 in the hollow portion 82, and is emitted to the outside of the rotary drive apparatus 1 through the lens 63 fitted in the through hole 84 of the tubular portion 81.

The mirror 61 of the flywheel 8 is arranged to reflect the incoming light 60 coming from the light source 6 and emit the reflected light 62 to the outside of the rotary drive apparatus 1 while rotating about the central axis 9 together with the rotating portion 3 of the motor 10. Thus, a wide range can be irradiated with light. Note that the rotation speed of the rotary drive apparatus 1 can be recognized by sensing the reflected light 62, which is emitted out of the flywheel 8, using an external sensor (not shown). Note that an outer circumferential surface of the flywheel 8 has a reflectivity lower than that of a front surface of the mirror 61. This contributes to preventing diffuse reflection of the incoming light 60 coming from the light source 6.

Note that the rotary drive apparatus 1 may further include, in addition to the above-described flywheel 8, another flywheel (not shown) which is arranged to emit reflected light to the outside in a second radial direction different from the first radial direction D1, and which is arranged, for example, below the motor 10. In this case, a half mirror the transmissivity and reflectivity of which are substantially equal is used as the mirror 61. Then, a half of the incoming light 60 which impinges on the mirror 61 in the flywheel 8 is reflected in the first radial direction D1 to be emitted to the outside. In addition, a remaining half of the incoming light 60 which impinges on the mirror 61 passes through the mirror 61, and travels downward through the aforementioned cavity (not shown) defined on and around the central axis 9 in the radially inner portion of the lower support portion 83. In addition, a through hole (not shown) passing through the motor 10 in the axial direction is defined around the central axis 9 in the motor 10. Thus, the portion of the incoming light 60 which has passed through the mirror 61 passes through the through hole and reaches the other flywheel arranged below the motor 10. Then, in the other flywheel, all the remaining half of the incoming light 60 is reflected in the second radial direction, using a fully reflective mirror (not shown), to be emitted to the outside. Note that a plurality of mirrors (not shown), including a half mirror, which are arranged to reflect the incoming light 60 in mutually different directions may alternatively be installed in the single flywheel 8 of the rotary drive apparatus 1.

When light is emitted out in two different directions as described above, light beams that are emitted out in the two different directions take different times to reach an object to be irradiated with light while the motor 10 is rotating, and this makes it possible to precisely recognize the three-dimensional position of the object in a space. Note that the other flywheel may alternatively be arranged in a rotary drive apparatus (not shown) other than the rotary drive apparatus 1 including the flywheel 8.

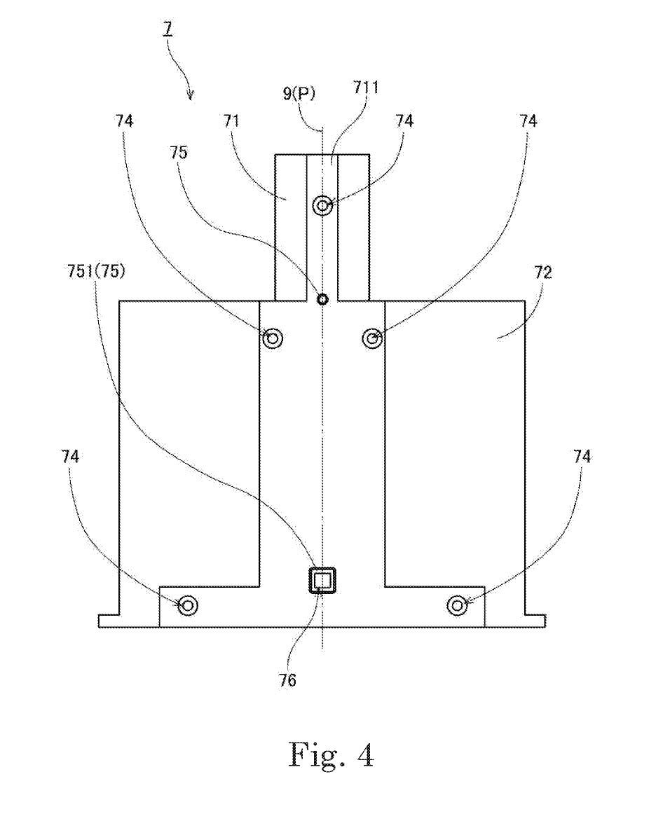

Next, the structures of the housing 7 and the casing 5 and a structure by which the housing unit 4 is positioned with respect to the casing 5 and is fixed to the casing 5 will now be described below. Hereinafter, reference will be made to FIGS. 1 to 3 appropriately as well as FIG. 4, which will be described below.

FIG. 4 is a planar view of the housing 7 according to the first preferred embodiment as viewed from the rear side of the housing 7. The housing 7 includes at least one tubular portion extending along the central axis 9. In addition, as suggested above, at least a portion of each optical component 90 and at least a portion of the rotary drive apparatus 1 are housed in the housing 7. A resin or a metal, for example, is used as a material of the housing 7. Use of the resin allows the housing 7 to be molded easily and at a low cost. Meanwhile, use of the metal leads to an improvement in dimensional accuracy of the housing 7. Referring to FIGS. 3 and 4, the housing 7 includes a first tubular portion 71 and a second tubular portion 72.

The first tubular portion 71 is a tubular portion arranged to extend along the central axis 9. The first tubular portion 71 has a first cavity 710, which is a cavity defined radially inside of the first tubular portion 71. At least a portion of the light source 6 is housed in the first cavity 710. In addition, the light source 6 is fixed to the first tubular portion 71 through screwing, press fitting, adhesion, fitting, engagement, or the like. Further, the first cavity 710 is connected to a second cavity 720, which is a cavity defined radially inside of the second tubular portion 72. Each of the first cavity 710 and the second cavity 720 includes a light path along which the incoming light 60 travels. In addition, the first tubular portion 71 includes a joining portion 711 arranged to extend toward a flat portion 51 of the casing 5, which will be described below, from one circumferential position in the first tubular portion 71 (in the present preferred embodiment, on the rear side of the first tubular portion 71).

The second tubular portion 72 is a tubular portion arranged to extend along the central axis 9 below the first tubular portion 71. The second tubular portion 72 is arranged to have a diameter greater than that of the first tubular portion 71. In the present preferred embodiment, the housing 7 further includes a flat portion 721 arranged to join an upper end portion of the second tubular portion 72 and a lower end portion of the first tubular portion 71 to each other. At least a portion of each optical component 90 and at least a portion of the rotary drive apparatus 1 are housed below the flat portion 721 and inside of the second tubular portion 72. Further, the rotary drive apparatus 1 is fixed to the second tubular portion 72 through screwing, press fitting, adhesion, fitting, engagement, or the like.

Next, the structure of the casing 5 will now be described below. Referring to FIG. 1, the casing 5 is arranged to have a rectangular external shape, having long sides and short sides, in a side plan view. In addition, the three-dimensional external shape of the casing 5 is a rectangular parallelepiped. Further, the casing 5 has a third cavity 50 defined inside thereof. The casing 5 is arranged to house the two (i.e., a plurality of) housing units in the third cavity 50. A resin or a metal, for example, is used as a material of the casing 5.

Referring to FIG. 3, the casing 5 includes the flat portion 51, which is arranged radially outside of the housing 7, and is arranged to extend perpendicularly to a radial direction. The flat portion 51 includes a first flat portion 511 arranged opposite to the first tubular portion 71, and a second flat portion 512 arranged opposite to the second tubular portion 72. In addition, the first and second flat portions 511 and 512 include one or more recessed portions 510. Each recessed portion 510 is recessed from a surface opposite to the housing 7 in a thickness direction of the flat portion 51. In addition, the housing 7 includes one or more projecting portions 75. Each projecting portion 75 is arranged to project toward the flat portion 51 from a surface of the second tubular portion 72 or the joining portion 711 of the first tubular portion 71, the surface being opposite to the flat portion 51. Then, each of the one or more projecting portions 75 is fitted into a corresponding one of the one or more recessed portions 510 of the flat portion 51. Each projecting portion 75 is thus arranged to be in contact with the casing 5 in at least one of the axial direction, the radial direction, and a circumferential direction. As a result, the housing 7 is positioned with respect to the casing 5. That is, in the present preferred embodiment, the one or more projecting portions 75 define one or more housing positioning portions each of which is arranged to position the housing 7 with respect to the casing 5.

Note that the flat portion 51 may include a through hole (i.e., a second through hole 500) arranged to pass through the flat portion 51 in the thickness direction thereof in place of the recessed portion(s) 510 or in addition to the recessed portion(s) 510. Referring to FIG. 3, the flat portion 51 according to the present preferred embodiment includes one recessed portion 510 in the first flat portion 511, and one second through hole 500 in the second flat portion 512. In addition, in the present preferred embodiment, two of the projecting portions 75 (one of which will be described below as a projecting portion 751), one of which is fitted into the one recessed portion 510 and another of which is fitted into the one second through hole 500, are arranged to overlap with each other when viewed in the axial direction.

In the present preferred embodiment, the housing 7, which includes the first tubular portion 71, the second tubular portion 72, and the projecting portions 75, is defined by a single monolithic member. Thus, the housing 7 can be molded using a single mold. This leads to a reduced production cost of the housing 7. In addition, with the projecting portions 75 for positioning being provided in the housing 7, which is arranged to house the light source 6 and the rotary drive apparatus 1, commonality of parts can be achieved. Thus, a reduced number of parts and a reduced production cost of apparatuses can be achieved. In addition, a reduced number of steps in an assembling process can be achieved, resulting in increased manufacturing efficiency. Further, the housing 7 according to the present preferred embodiment includes the housing positioning portion at each of the first and second tubular portions 71 and 72. This leads to an increase in the precision with which the housing 7 is positioned with respect to the casing 5.

Here, in the present preferred embodiment, the projecting portions 75 are provided in the housing 7, while the recessed portion 510 and the second through hole 500 are provided in the casing 5. If a projecting portion(s) and a recessed portion(s) were provided in the casing 5 and the housing 7, respectively, and each projecting portion were fitted into the corresponding recessed portion to accomplish positioning (see a modification of the first preferred embodiment, which will be described below), it would be difficult to maintain strength of the housing 7. This is because combining the provision of the recessed portion(s) in the housing 7 with a sufficient thickness of the housing 7 to maintain the strength of the housing 7 would require the housing 7 to be so thick as to limit a space for the rotary drive apparatus 1 to be housed in the housing 7. In contrast, in the present preferred embodiment, the projecting portions 75 are provided in the housing 7, while the recessed portion 510 and the second through hole 500 are provided in the casing 5. This leads to increased flexibility in designing the rotary drive apparatus 1, such as, for example, designing the sizes of the motor 10 and the flywheel 8.

In addition, in the present preferred embodiment, one of the two projecting portions 75, which define the housing positioning portions, i.e., the projecting portion 751 which is arranged to be fitted into the second through hole 500, is arranged to have a rectangular cross-section. The rectangular cross-section, rather than a circular cross-section, of the projecting portion 751 contributes to more effectively preventing a displacement of the housing 7 with respect to the casing 5. This in turn contributes to increased stability in holding the housing 7.

Further, in the present preferred embodiment, the projecting portion 751, which is arranged to project from the second tubular portion 72, includes a third through hole 76 defined therein. The third through hole 76 is arranged to pass through the projecting portion 751 in the thickness direction of the flat portion 51. The rotating portion 3 of the motor 10 is exposed to an outside of the casing unit 100 through the third through hole 76. If infrared rays, light beams, or the like are emitted toward the third through hole 76 from the outside of the casing unit 100, for example, when the rotating portion 3 is rotating while the rotary drive apparatus 1 is running, the infrared rays, the light beams, or the like are reflected by an exposed portion of the rotating portion 3. Then, the rotation speed of the rotary drive apparatus 1 can be recognized by sensing the reflected infrared rays, light beams, or the like with an infrared sensor, a photoelectric sensor, or the like (not shown) arranged outside of the casing unit 100. Thus, the third through hole 76 defined in the projecting portion 751, which performs a function as a positioning portion to position the housing 7 with respect to the casing 5, is able to perform a function as an opening to make it possible to recognize the rotation speed of the rotary drive apparatus 1. This allows the structure of a mold used when defining the housing 7 by a resin injection molding process to be simpler than in the case where portions that perform the above two functions are provided separately. Thus, the housing 7 can be molded with increased ease, resulting in increased productivity.

Next, the structure by which the housing unit 4 is fixed to the casing 5 will now be described below. Referring to FIG. 3, the flat portion 51 of the casing 5 includes a plurality of first through holes 52. Each of the first through holes 52 is arranged to pass through the flat portion 51 in the thickness direction thereof at a position opposite to the housing 7. Each of the first through holes 52 is defined at a position different from that of each of the aforementioned recessed portion 510 and the aforementioned second through hole 500. In addition, the first through holes 52 are defined at one or more positions in each of the first and second flat portions 511 and 512. Here, the first and second flat portions 511 and 512 are included in the same flat face of the casing 5. Thus, the casing 5 has a simpler structure than in the case where the first through holes 52 are defined in different faces of the casing 5. This leads to a reduced size of the casing unit 100 as a whole.

Next, the first and second tubular portions 71 and 72 include a plurality of screw holes 74 each of which is recessed radially inward from at least a portion of an outer circumferential surface thereof at a position opposite to a separate one of the first through holes 52 in a thickness direction of the casing 5. Then, each of a plurality of screws 91, each of which is arranged to pass through a corresponding one of the first through holes 52, is inserted into a corresponding one of the screw holes 74 to fix the housing 7 to the casing 5 through screwing. Thus, the housing 7 can be fixed to the casing 5 with a reduced number of parts and a reduced cost. In addition, a reduced number of steps in the assembling process can be achieved, resulting in increased manufacturing efficiency. Further, the housing 7 can be held with increased stability with each of the first and second tubular portions 71 and 72 being fixed to the casing 5 to ensure sufficient fixing strength.

Note that the positions at which the housing 7 is fixed to the casing 5 through screwing are preferably as far away from one another as possible. For example, a distance between at least two of the first through holes 52 is preferably three-quarters or more of an axial dimension of the housing 7. This will contribute to fixing the housing 7 to the casing 5 in a well-balanced manner, and holding the housing 7 with increased stability. In addition, at least two pairs of the aforementioned first through holes 52 and the aforementioned screw holes 74 are arranged symmetrically with respect to a plane P (see FIGS. 2 and 4) including the central axis 9 and extending in the first radial direction D1. This contributes to fixing the housing 7, in which the light source 6 and the rotary drive apparatus 1 are housed, to the casing 5 in a well-balanced manner, and holding the housing 7 with increased stability.

Referring to FIGS. 2 and 3, the second tubular portion has an opening portion 70 defined at at least one circumferential position. In the present preferred embodiment, about a circumferential half of a side surface of the rotary drive apparatus 1 is exposed to the opening portion 70. In addition, at least a portion of the casing 5, the portion including a portion overlapping with the opening portion 70 when viewed in a radial direction, is arranged to open outwardly. The incoming light 60 coming from the light source 6 travels downward along the central axis 9, and enters into the flywheel 8 through the first cavity 710 and the second cavity 720. Then, the reflected light 62, which has been reflected by the mirror 61, travels outward in the first radial direction D1, is emitted to the outside of the rotary drive apparatus 1 through the lens 63 and the opening portion 70 to impinge on a target object outside of the casing 5.

While a preferred embodiment of the present invention has been described above, it will be understood that the present invention is not limited to the above-described preferred embodiment.

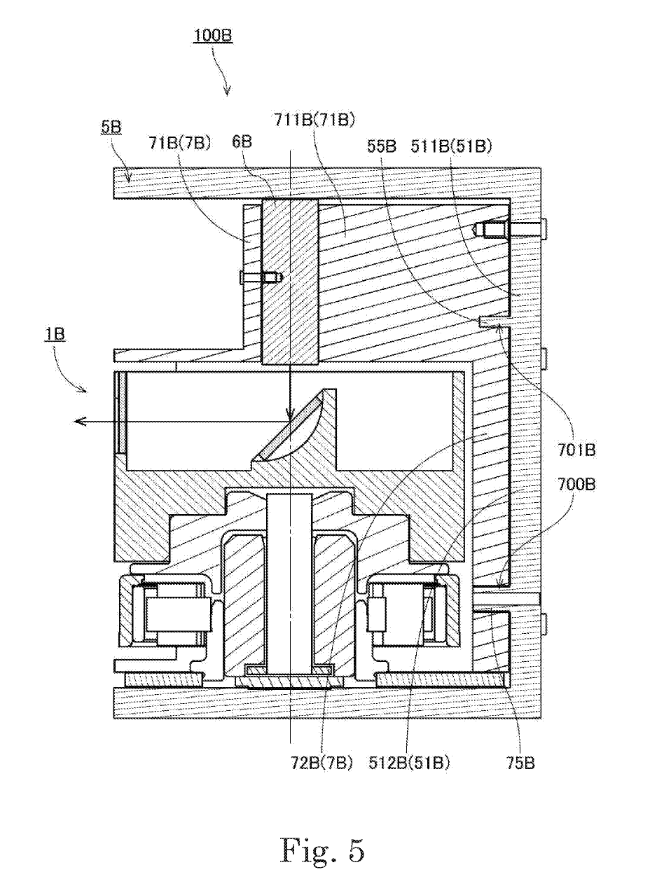

FIG. 5 is a vertical sectional view of a casing unit 100B according to a modification of the first preferred embodiment. In the modification illustrated in FIG. 5, a second tubular portion 72B and a joining portion 711B of a first tubular portion 71B of a housing 7B include one or more second through holes 700B each of which is arranged to pass through the housing 7B in a thickness direction of the housing 7B at a position opposite to a flat portion 51B, and/or one or more recessed portions 701B each of which is recessed at a position opposite to the flat portion 51B. In addition, the flat portion 51B includes one or more projecting portions 55B each of which is arranged to project from the flat portion 51B toward the housing 7B. Then, each of the one or more projecting portions 55B is fitted into a corresponding one of the one or more recessed portions 701B and the one or more second through holes 700B. Thus, each of the one or more recessed portions 701B and/or each of the one or more second through holes 700B is arranged to be in contact with the flat portion 51B of a casing 5B in at least one of the axial direction, the radial direction, and the circumferential direction. As a result, the housing 7B is positioned with respect to the casing 5B. That is, in the present modification, the one or more recessed portions 701B and/or the one or more second through holes 700B define one or more housing positioning portions each of which is arranged to position the housing 7B with respect to the casing 5B.

In the modification illustrated in FIG. 5, the housing 7B, which includes the first tubular portion 71B, the second tubular portion 72B, the recessed portion(s) 701B, and the second through hole(s) 700B, is defined by a single monolithic member. In addition, each projecting portion 55B is an integral portion of the casing 5B. Thus, each of the housing 7B and the casing 5B can be molded using a single mold, which leads to a reduced production cost. In addition, with the recessed portion(s) 701B and the second through hole(s) 700B for positioning being provided in the housing 7B, which is arranged to house a light source 6B and a rotary drive apparatus 1B, commonality of parts can be achieved. Thus, a reduced number of parts and a reduced production cost of apparatuses can be achieved. In addition, a reduced number of steps in an assembling process can be achieved, resulting in increased manufacturing efficiency. Further, the housing 7B according to the modification illustrated in FIG. 5 includes the housing positioning portion at each of the first and second tubular portions 71B and 72B. This leads to an increase in the precision with which the housing 7B is positioned with respect to the casing 5B.

Note that the detailed shape of any member may be different from the shape thereof as illustrated in the accompanying drawings of the present application. Also note that features of the above-described preferred embodiments and the modifications thereof may be combined appropriately as long as no conflict arises.

Preferred embodiments of the present invention are applicable to, for example, casing units.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A casing unit comprising a housing unit and a casing arranged to house therein at least a portion of the housing unit, the housing unit including a housing arranged to house therein at least a portion of a rotary drive apparatus arranged to cause incoming light coming from a light source to be emitted to an outside of the rotary drive apparatus while changing a direction of the incoming light, wherein
the housing includes:
a first tubular portion being tubular, and arranged to extend along a central axis extending in a vertical direction; and
a second tubular portion being tubular, and arranged to extend along the central axis below the first tubular portion;
the first tubular portion is arranged to house therein at least a portion of the light source;
the second tubular portion is arranged to house therein at least a portion of the rotary drive apparatus;
a cavity radially inside of the housing includes a light path along which the incoming light travels;
the housing further includes, at each of the first and second tubular portions, one or more housing positioning portions each of which is arranged to be in contact with the casing in at least one of an axial direction, a radial direction, and a circumferential direction; and
the housing is defined by a single monolithic member including the housing positioning portions.

2. The casing unit according to claim 1, wherein
the casing includes a flat portion arranged radially outside of the housing, and arranged to extend perpendicularly to the radial direction;
the flat portion includes a plurality of first through holes each of which is arranged to pass through the flat portion in a thickness direction thereof at a position opposite to the housing; and
the housing is fixed to the casing through a plurality of screws each of which is arranged to pass through a corresponding one of the first through holes.

3. The casing unit according to claim 2, wherein
the flat portion includes:
a first flat portion arranged opposite to the first tubular portion; and
a second flat portion arranged opposite to the second tubular portion; and
the casing includes one or more of the first through holes in each of the first and second flat portions.

4. The casing unit according to claim 2, wherein a distance between at least two of the first through holes is three-quarters or more of an axial dimension of the housing.

5. The casing unit according to claim 2, wherein
at least one of the housing positioning portions is a projecting portion arranged to project toward the flat portion from a surface of the first tubular portion or the second tubular portion, the surface being opposite to the flat portion;
the flat portion includes, at a position opposite to the first tubular portion or the second tubular portion and different from that of each first through hole, a recessed portion being recessed or a second through hole arranged to pass through the flat portion in the thickness direction thereof; and
the projecting portion is arranged to be fitted into the recessed portion or the second through hole.

6. The casing unit according to claim 2, wherein
at least one of the housing positioning portions is a recessed portion being recessed or a second through hole arranged to pass through the housing in a thickness direction thereof at a position opposite to the flat portion in the first tubular portion or the second tubular portion;
the flat portion includes one or more projecting portions each of which is arranged to project toward the housing from a surface thereof opposite to the first tubular portion or the second tubular portion; and
each projecting portion is arranged to be fitted into the corresponding recessed portion or the corresponding second through hole.

7. The casing unit according to claim 5, wherein at least one of the housing positioning portions is arranged to have a rectangular cross-section.

8. The casing unit according to claim 1, wherein at least two of the housing positioning portions are arranged to overlap with each other when viewed in the axial direction.

9. The casing unit according to claim 2, wherein
at least one of the housing positioning portions is a projecting portion arranged to project toward the flat portion from a surface of the second tubular portion, the surface being opposite to the flat portion;
the flat portion includes, at a position opposite to the second tubular portion and different from that of each first through hole, a second through hole arranged to pass through the flat portion in the thickness direction thereof;
the projecting portion is arranged to be fitted into the second through hole;
the housing further includes a third through hole arranged to pass through the projecting portion in the thickness direction of the flat portion;
the rotary drive apparatus includes:
a motor including a rotating portion arranged to rotate about the central axis; and
a flywheel supported by the rotating portion, caused by the rotating portion to rotate about the central axis, and including an optical component arranged to change the direction of the incoming light or allow the incoming light to pass therethrough; and
the rotating portion is exposed to an outside through the third through hole.

10. The casing unit according to claim 1, wherein the housing is made of a resin.

11. The casing unit according to claim 1, wherein the housing is made of a metal.

12. The casing unit according to claim 1, wherein the casing is made of a resin.

13. The casing unit according to claim 1, wherein the casing is made of a metal.
